(19) United States
(12) Patent Application Publication
(10) Pub. No.: US 2016/0211734 A1
(43) Pub. Date: Jul. 21, 2016

(54) Vibration Motor

(71) Applicant: Changliang Wang, Shenzhen (CN)

(72) Inventor: Changliang Wang, Shenzhen (CN)

(73) Assignee: AAC Technologies Pte. Ltd., Singapore city (SG)

(21) Appl. No.: 14/979,418

(22) Filed: Dec. 27, 2015

(30) Foreign Application Priority Data
Jan. 16, 2015 (CN) 201520031587.2

(51) Int. Cl. H02K 33/00

(52) U.S. Cl. CPC H02K 33/00

(57) ABSTRACT

A vibration motor is disclosed. The vibration motor includes: a housing; a vibration part arranged in the housing, the vibration part including a first surface, a second surface opposite to the first surface and a lateral surface connecting the first surface with the second surface; an elastic connecting piece used for suspending the vibration part in the housing, the elastic connecting piece including a first end connected with the lateral surface of the vibration part and a second end connected with the housing; and fastening pieces arranged on the first end and connected with the first surface and second surface of the vibration part, respectively. By virtue of the configuration disclosed, the manufacturing process is simple.

### FIELD OF THE INVENTION

The present disclosure is related to vibration motors, specifically related to a vibration motor for portable consumer electronic products.

### DESCRIPTION OF RELATED ART

A vibration motor is applied to feedback of system generally, for example, incoming call prompt, message prompt and navigation prompt of mobile phone, vibration feedback of game player, etc. for portable consumer electronic products, such as mobile phone, handheld game player, navigation unit or handheld multimedia entertainment equipment which is more and more popular with people along with the development of the electronic technique.

The vibration motor 10 of the related technology includes a housing (unlabeled), a vibration part 11 arranged in the housing and an elastic connecting piece 12 used for suspending the vibration part 11 in the housing. The elastic connecting piece includes two ends, one end being connected with the housing, and the other end being connected with the vibration part 11. The end connected with the vibration part 11 is required to be weld with the vibration part 11 in a Y direction to form three welding spots (unlabeled) in the Y direction; and then a baffle plate 13 is welded with the elastic connecting piece 12 and vibration part 11 along a Z direction to form 4 welding spots 14 at the upper and lower sides. The baffle plate 13 plays a role of protecting the three welding spots in the Y direction.

The related structure mainly has following disadvantages:

1. When welding in the Z direction, because the welding is performed for three components made of three kinds of material, the requirements on the welding process are high, the components are difficult to be welded well, and welding spots are easy to peel off.

2. Because residual stress, micro-cracks, air holes and the like exist in the welding zone, the welding zone is often the weak position of the component and is easy to rupture due to high stress level during the vibration of the vibration part.

3. The use of the baffle plate would enable the manufacturing cost to be increased.

Therefore, it is necessary to provide a new vibration motor to overcome the problems mentioned above.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an illustrative isometric view of a related vibration motor.

FIG. 2 is an illustrative isometric view of a vibration motor in accordance with an exemplary embodiment of the present invention.

FIG. 3 is an enlarged view of Part A of FIG. 2.

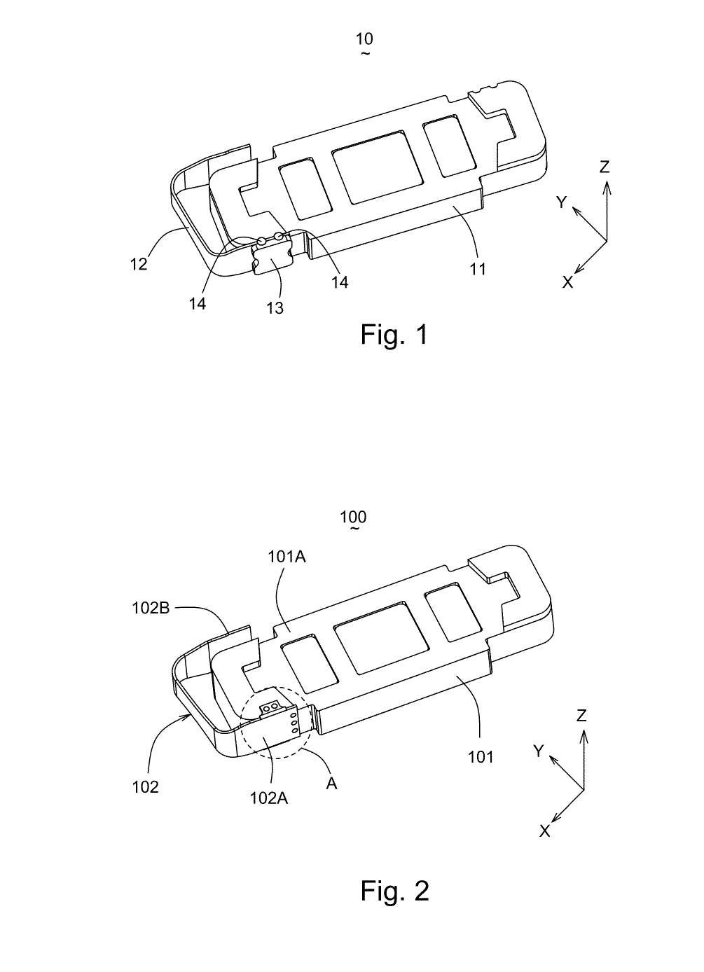

### DETAILED DESCRIPTION OF THE EXEMPLARY EMBODIMENT

The present invention will hereinafter be described in detail with reference to an exemplary embodiment. To make the technical problems to be solved, technical solutions and beneficial effects of present disclosure more apparent, the present disclosure is described in further detail together with the figures and the embodiment. It should be understood the specific embodiment described hereby is only to explain this disclosure, not intended to limit this disclosure.

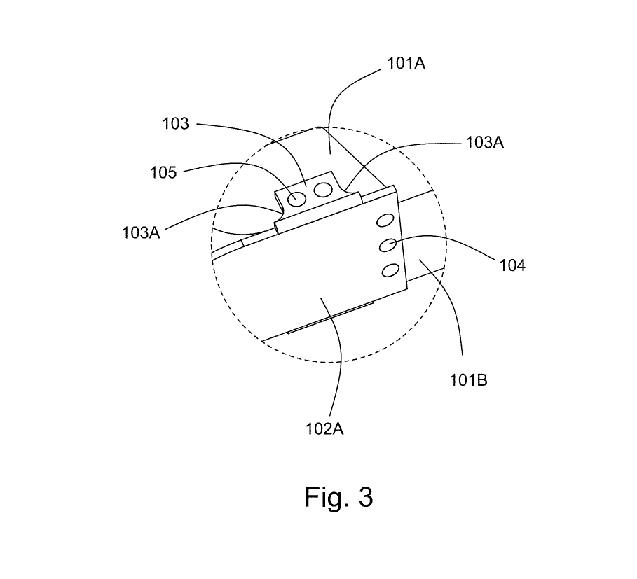

As shown in FIGS. 2-3, a vibration motor 100 in accordance with an exemplary embodiment of the present disclosure includes a housing (unlabeled), a vibration part 101 arranged in the housing and an elastic connecting piece 102 used for suspending the vibration part 101 in the housing. The vibration part 101 includes a first surface 101A, a second surface (unlabeled) opposite to the first surface 101A and a lateral surface 101B connecting the first surface 101A with the second surface. The elastic connecting piece 102 includes a first end 102A welded with the lateral surface 101B of the elastic connecting piece 101 and a second end 102B welded with the housing.

The first end 102A includes an upper edge near the first surface 101A and a lower edge near the second surface, and a fastening piece 103 respectively extending from the upper edge and lower edge towards the first surface 101A and second surface. The fastening piece 103 is rectangular, and fillets 103A are arranged at a joint of the upper edge and the fastening piece 103, and at a joint of the lower edge and the fastening piece 103 so as to avoid stress concentration.

According to the exemplary embodiment of the disclosure, three welding spots 104 are arranged on the first end 102A and lateral surface 101B at intervals along a direction from the first surface 101A to the second surface, and the first end 102A is welded with the vibration part 101 along a Y direction in the figure by the welding spots 104. Two welding spots 105 are arranged on the fastening piece 103 at intervals along an X direction, and the fastening piece 103 is welded with the vibration part 101 along a Z direction by the two welding spots 105.

Both the welding between the fastening piece 103 and the vibration part 101 and the welding between the first end 102A and the vibration part 101 belong to plane welding between two components, and therefore, the welding process is simple, and the welding intensity is high. Compared with a traditional structure, a baffle plate is omitted, and therefore, the production cost is lowered.

It is to be understood, however, that even though numerous characteristics and advantages of the present embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A vibration motor including:
a housing;
a vibration part arranged in the housing, the vibration part including a first surface, a second surface opposite to the first surface and a lateral surface connecting the first surface with the second surface;
an elastic connecting piece used for suspending the vibration part in the housing, the elastic connecting piece including a first end connected with the lateral surface of the vibration part and a second end connected with the housing;
fastening pieces arranged on the first end and connected with the first surface and second surface of the vibration part, respectively.

2. The vibration motor as described in claim 1, wherein the first end includes an upper edge near the first surface and a lower edge near the second surface, and the fastening pieces extends towards the first surface and the second surface from the upper edge and lower edge.

3. The vibration motor as described in claim 2, wherein the fastening piece further includes a fillet arranged at each of the joints between the fastening piece and the upper edge, and between the fastening piece and the lower edge.

4. The vibration motor as described in claim 1, wherein three welding spots are arranged on the first end along a direction from the first surface to the second surface.

5. The vibration motor as described in claim 4, wherein two welding spots are arranged on the fastening piece.
